(19) United States
(12) Patent Application Publication
(10) Pub. No.: US 2025/0262823 A1
(43) Pub. Date: Aug. 21, 2025

(54) ADDITIVE MANUFACTURING QUALITY CONTROL

(71) Applicant: Interspectral AB, Norrköping (SE)

(72) Inventors: Karl Lindberg, Kolmården (SE); Fredrik Johnson, Norrköping (SE)

(21) Appl. No.: 18/778,091

(22) Filed: Jul. 19, 2024

Related U.S. Application Data
(60) Provisional application No. 63/655,892, filed on Jun. 4, 2024.
(60) Provisional application No. 63/527,808, filed on Jul. 19, 2023.

(51) Int. Cl. B29C 64/386; B33Y 50/00

(52) U.S. Cl. CPC B29C 64/386; B33Y 50/00

(57) ABSTRACT

Disclosed, in one general aspect, is an additive manufacturing quality control method that includes receiving physical property measurement data values from different spatial positions for a three-dimensional part manufactured with an additive manufacturing process, and defining a three-dimensional quality measurement volume of quality measurement voxels that are each associated with at least one quality control measure and at least one quality evaluation method. The three-dimensional quality measurement volume of quality measurement voxels is formatted in a three-dimensional format in which one set of the quality measurement voxels are voxels of one size, and at least another set of the quality measurement voxels are voxels of a different size. The quality measurement voxels can define voxels each associated with a vector of the quality measures and a vector of the quality evaluation methods. The measurement data values may for example be acquired from various sensors during the additive manufacturing process.

### CROSS-REFERENCE TO RELATED APPLICATION

This application is claims priority to U.S. provisional application No. 63/527,808, filed Jul. 19, 2023, and to U.S. provisional application No. 63/655,892, filed Jun. 4, 2024. It is also related to PCT application No. PCT/EP2024/070639, filed Jul. 19, 2024. These three documents are all herein incorporated by reference.

### FIELD OF THE INVENTION

This invention relates to methods and apparatus for obtaining and processing information from additive manufacturing processes that can be used to understand, evaluate, and improve the quality of manufactured parts.

### BACKGROUND OF THE INVENTION

Additive manufacturing is a rapidly growing field that has the potential to revolutionize the manufacturing industry. However, ensuring the quality of the parts produced through additive manufacturing can be challenging due to the complexity of the process. Current quality control methods often rely on visual inspection or post-processing analysis, which can be time-consuming and expensive.

### SUMMARY OF THE INVENTION

In one general aspect, the invention features an additive manufacturing quality control method that includes receiving physical property measurement data values from different spatial positions acquired for a three-dimensional part manufactured with an additive manufacturing process, and defining a three-dimensional quality measurement volume of quality measurement voxels that are each associated with at least one quality control measure and at least one quality evaluation method. The three-dimensional quality measurement volume of quality measurement voxels is formatted in a three-dimensional format in which one set of the quality measurement voxels are voxels of one size, and at least another set of the quality measurement voxels are voxels of a different size.

In preferred embodiments, the defining a three-dimensional quality measurement volume of quality measurement voxels can define voxels that are each associated with a vector of the quality measures and a vector of the quality evaluation methods. The method can further include evaluating the physical property measurement data values based on the quality evaluation measures and quality evaluation methods for corresponding voxels in the three-dimensional volume of quality measurement voxels. The evaluation can be performed in-situ during the additive manufacturing process. The evaluation can be performed after completion of the additive manufacturing process. The method can further include storing results of the evaluating in a three-dimensional quality evaluation result volume. The method can further include visualizing the result using a graphical device. The visualizing can provide a detailed representation of a final part, including any areas that deviate from desired quality standards. The three-dimensional quality measurement volume and the three-dimensional quality evaluation result volume can share a same resolution. The three-dimensional quality measurement volume of quality measurement voxels can be adjusted by a feedback loop based on the results of evaluations. The three-dimensional quality measurement volume of quality measurement voxels can be derived through machine learning. The differently sized voxels in the three-dimensional volume of quality measurement voxels can be obtained by down-sampling of the quality evaluation methods for some of the voxels. The down sampling can be performed by adding methods of contributing voxels and assigning a weight to each of the contributing voxels to calculate a quality measure by interpolation. The property measurements can include emitted radiation from a melt pool, measured laser power, and measured laser position. The property measurements can be in point-cloud format. The method can further include storing the defined three-dimensional quality measurement volume of quality measurement voxels in a file structure that includes a spatial tree. The method can further include storing the defined three-dimensional quality measurement volume of quality measurement voxels in a sequence that is organized to allow efficient access and caching of information for proximate voxels. The measurement data values may for example be acquired from various sensors during the additive manufacturing process.

In another general aspect, the invention features an additive manufacturing quality control system that includes an input for receiving physical property measurement data values from different spatial positions acquired for a three-dimensional part manufactured with an additive manufacturing process, logic for defining a three-dimensional quality measurement volume of quality measurement voxels that are each associated with at least one quality control measure and at least one quality evaluation method, and wherein the three-dimensional quality measurement volume of quality measurement voxels is formatted in a three-dimensional format in which a first set of the quality measurement voxels are voxels of a first size, and at least a second set of the quality measurement voxels are of a second size different from the first size. The measurement data values may for example be acquired from various sensors during the additive manufacturing process.

In another general aspect, the invention features an additive manufacturing quality control system that includes means for receiving physical property measurement data values from different spatial positions acquired for a three-dimensional part manufactured with an additive manufacturing process, means for defining a three-dimensional quality measurement volume of quality measurement voxels that are each associated with at least one quality control measure and at least one quality evaluation method, and wherein the three-dimensional quality measurement volume of quality measurement voxels is formatted in a three-dimensional format in which a first set of the quality measurement voxels are voxels of a first size, and at least a second set of the quality measurement voxels are of a second size different from the first size. The measurement data values may for example be acquired from various sensors during the additive manufacturing process.

Systems and methods for additive manufacturing quality control according to the invention can address challenges associated with evaluating and improving the quality of parts produced through additive manufacturing. They can enable real-time monitoring and evaluation of the additive manufacturing process, ensuring high-quality parts with minimal defects are produced. And they can be used with various types of additive manufacturing processes and materials and can provide various benefits, including reduced production time and cost and improved part performance. Systems and methods according to the invention can also include machine learning components and feedback loops for further optimization and improvement. The use of a graphical device to visualize the quality control results can provide several benefits and enhance the overall quality control process for additive manufacturing.

### BRIEF DESCRIPTION OF THE DRAWING

FIG. 1 is a block diagram of a manufacturing quality control system according to the invention;

FIG. 2 is a more detailed diagram of quality control portions of the system of FIG. 1;

FIG. 3 is a diagram illustrating operations performed by the system of FIG. 1;

FIG. 4 is a more detailed view of a quality measurement volume as shown in FIG. 3; and

FIG. 5 is a more detailed view of a quality result volume as shown in FIG. 3.

FIGS. 6A-F are diagrams that illustrate the operation of the system of FIG. 1 on an illustrative data set;

FIG. 7 is a diagram illustrating the operation of the system of FIG. 1 in more detail on subsets of the data set of FIG. 6;

FIG. 8 is a memory/cache diagram for the data subsets of FIG. 7;

FIG. 9 is a diagram summarizing an illustrative overall quality control operation for the system of FIG. 1; and

FIG. 10 is a diagram summarizing the same illustrative overall quality control operation that is presented in FIG. 9, except that it uses larger voxel sizes to convey how using variable voxel sizes can affect the result data set.

### DETAILED DESCRIPTION OF AN ILLUSTRATIVE EMBODIMENT

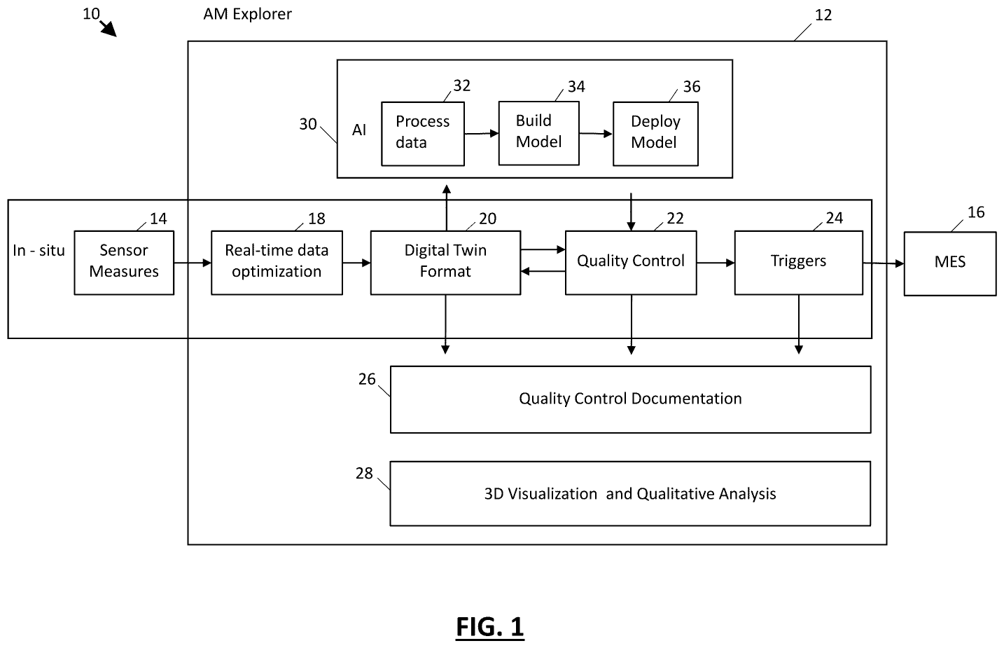

Referring to FIG. 1, an illustrative manufacturing quality control system 10 according to the invention includes a quality control and visualization system 12 that can receive sensor values 14 from an additive manufacturing process and provide build parameters to a manufacturing execution system 16. It can also include a real-time data optimization module 18 to optimize the received sensor values, and storage for these optimized values, which can be stored in digital twin format 20. A quality control module 22 is operative to access the stored data and will be described in more detail below. A trigger detection module 24 is responsive to the quality control module and is operative to provide adjusted build parameters to the manufacturing execution system 16 based on quality evaluation information derived from the sensor values by the quality control subsystem.

The manufacturing quality control system 10 can also include an Artificial Intelligence (AI)-based quality control adjustment subsystem 30. This subsystem includes a data processing module 32 that can receive optimized sensor values. It can also include a model building module 34 that is operative to build models based on the optimized sensor values processed by the data processing module. A model deployment module 36 is responsive to the model building module to deploy new quality control models to the quality control module 22.

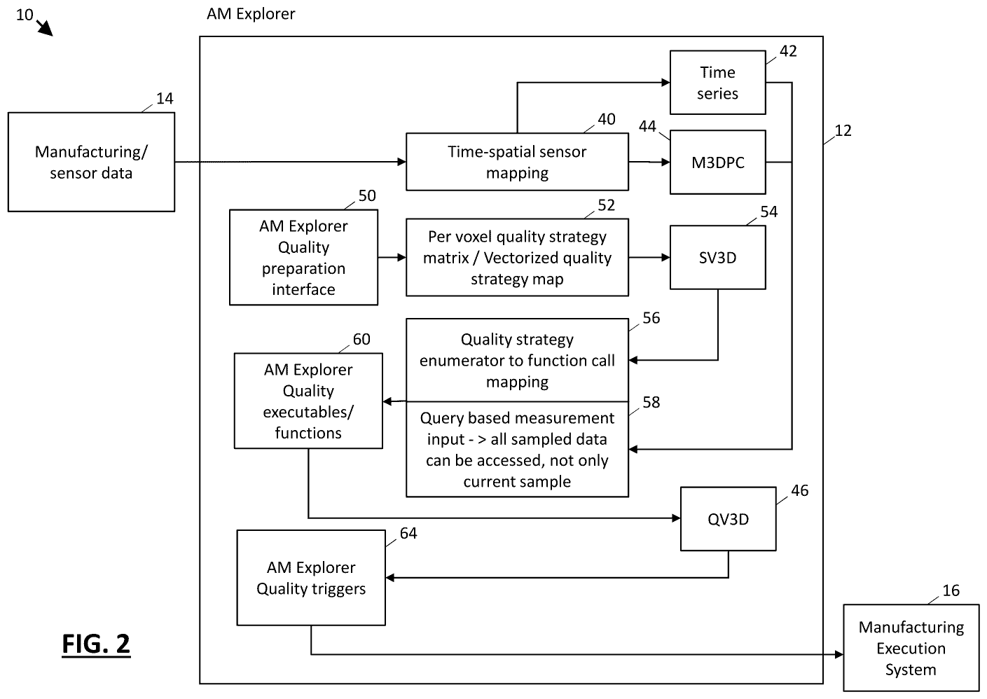

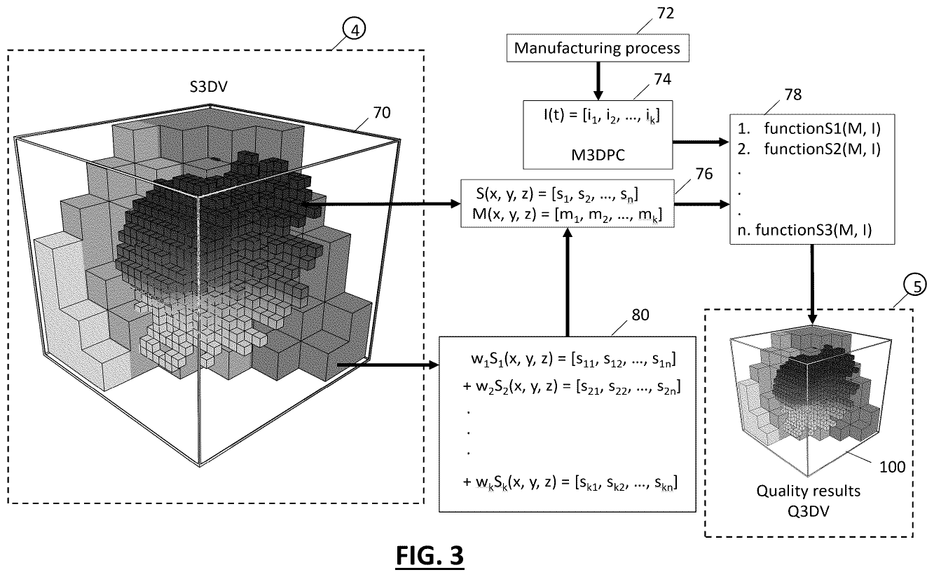

Referring to FIG. 2, the manufacturing quality control system 10 includes a time-spatial sensor mapping module 40 that receives the sensor values 14, and outputs them as a non-spatial time series (TS) 42 and a three-dimensional point cloud data set (PC3D) 44. The time series can contain sensor data which cannot be mapped to a point in space, air flow, chamber temperature, chamber pressure, humidity, but still affects the result of the three-dimensional point cloud data set. The time series data can also in some situations be used more efficiently in interpolations than the point cloud data can.

The manufacturing quality control system can also receive a voxel quality strategy matrix and vectorized quality strategy map from an additive manufacturing quality preparation interface, which may be operated by an end user through a manual user interface. The matrix and map are stored as a three-dimensional quality measurement volume (SV3D) 54. The system further includes a quality strategy enumerator to function cell mapping module 56 and a query-based measurement input module 58, which can access the latest sample or any previously measured sample that has been stored. A quality evaluation module 60 applies quality executables and functions to the output of these blocks, and the resulting data is stored as a three-dimensional result data set (QV3D) 46.

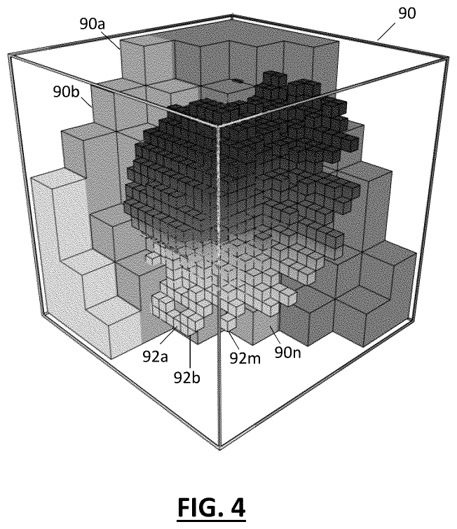

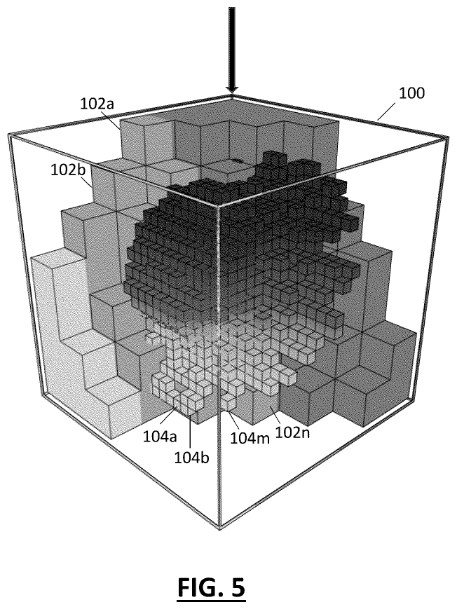

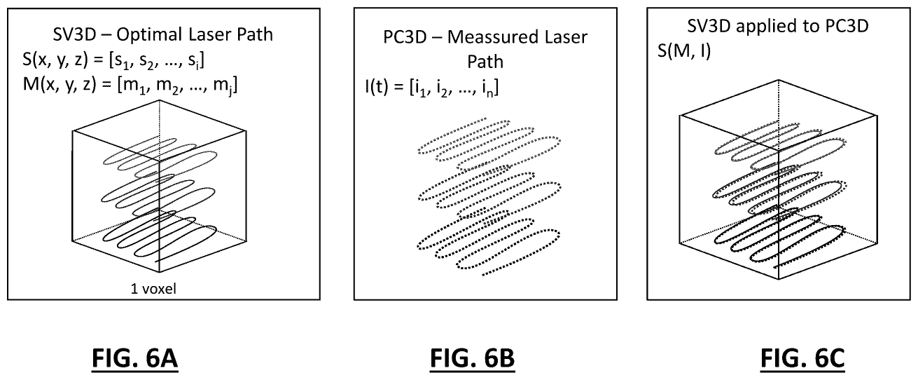

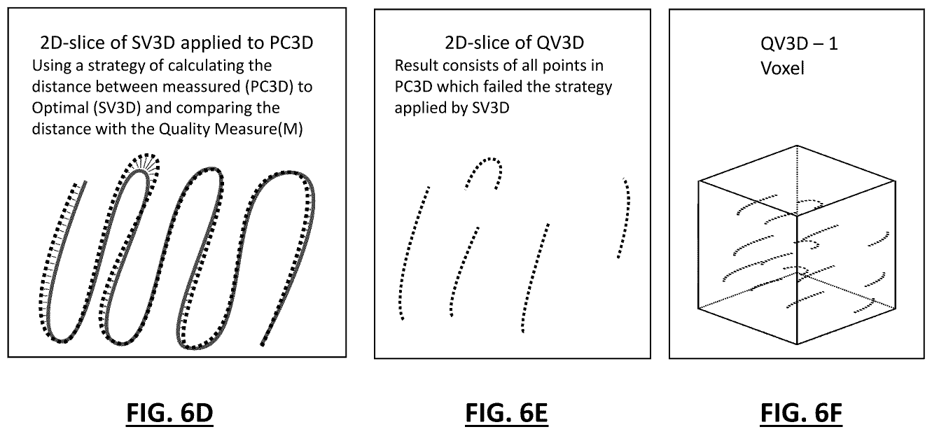

Referring to FIGS. 1-5, the manufacturing quality control system 10 stores the three-dimensional measurement volume in a three-dimensional format 70 that includes voxels of two or more different sizes, such as larger voxels 90a, 90b, . . . 90n and smaller voxels 92a, 92b, and 92n (76). And each of these voxels is associated with one quality measure or preferably a vector of quality measures [S₁, S₂, Sᵢ] and a quality evaluation method or preferably a vector of quality evaluation methods [M₁, M₂, Mᵢ]. The system applies (78) these measures and methods to the sensor data (74) to obtain a three-dimensional result data set 100. The result data set can also include voxels of two or more different sizes, such as larger voxels 102a, 102b, . . . 102n and smaller voxels 104a, 104b, and 104n (76). The vectors can include parameters used in the functions in each voxel. These parameters can for example control how functions sample in previously collected data or evaluated data.

In one general aspect, operation of the manufacturing quality control system 10 includes the following steps:
Measuring material deposition properties or powder bed fusion properties together with other process measures during the additive manufacturing process. The measurements can be taken using sensors or other suitable devices and can include data such as temperature, laser power, and speed.
Saving the measured data in a structured 3D point cloud. The point cloud can be stored in a database or other suitable storage medium and can be used for further analysis and evaluation.
Defining a quality measure strategy as a 3D volume. The quality measure strategy can be predefined based on the desired quality of the parts produced through additive manufacturing. Each voxel in the 3D volume can contain a vector of quality measures and vector of quality evaluation methods represented as an enumerator.
Defining the 3D volume in different levels of detail. The levels of detail can vary based on the desired resolution and accuracy of the quality evaluation. In lower levels of detail (larger voxels), the down-sampling of the quality evaluation methods can be performed by using weighted averages of the contributing voxels, for example, using bicubic interpolation. Lower levels of detail enable faster quality evaluation, but less precision.
Evaluating the 3D point cloud against the 3D volume continuously. The evaluation can be performed using suitable algorithms and can provide real-time feedback on the quality of the parts being produced. The evaluation can also be performed at different levels of detail based on the resolution and accuracy of the 3D volume.

In addition to the features described earlier, the quality control approach for additive manufacturing described in this document can include a 3D point cloud that represents the ideal laser path or material deposition nozzle path. This 3D point cloud can be generated using computer-aided design (CAD) software and can represent the optimal path for the laser or nozzle to follow during the manufacturing process. During or after the actual manufacturing process, the measured 3D point cloud positions can be compared against this ideal path and create a measure that can be used by methods defined in the quality 3D volume to detect any deviations or defects in the final part.

The 3D point cloud representing the ideal laser path can be used in combination with the predefined quality measure strategy defined as a 3D volume to provide a comprehensive evaluation of the additive manufacturing process. By continuously evaluating the 3D point cloud against the 3D volume, any areas of the part that deviate from the desired quality standards can be detected, allowing for immediate feedback and adjustments to the manufacturing process.

The use of a 3D point cloud representing the ideal laser path can provide additional benefits, including:
Improved part accuracy and consistency: By comparing the actual manufacturing process against the ideal laser path, this approach can ensure that each part is produced with high accuracy and consistency.
Reduced material waste: By minimizing deviations and defects in the final part, this approach can reduce the amount of material waste generated during the manufacturing process.
Increased design flexibility: The use of a 3D point cloud representing the ideal laser path can allow for increased design flexibility, as this approach can adapt to complex and intricate designs while maintaining high quality standards.

The addition of a 3D point cloud representing the ideal laser path to the quality control process for additive manufacturing described in this document can provide additional benefits and improve the overall quality of the final part.

Systems and methods according to the invention can be used with various types of additive manufacturing processes, including powder bed fusion, directed energy deposition, and material extrusion. They can also be used with various types of materials, including metals, polymers, and composites.

Systems and methods according to the invention can provide various benefits, including:
Real-time quality control: Systems and methods according to the invention can enable real-time monitoring and evaluation of the additive manufacturing process, allowing for immediate feedback and adjustments if necessary.
Reduced production time and cost: By ensuring high-quality parts with minimal defects, systems and methods according to the invention can reduce the need for post-processing and rework, resulting in reduced production time and cost.
Improved part performance: Systems and methods according to the invention can ensure that parts produced through additive manufacturing meet desired quality standards, resulting in improved part performance and reliability.

In one embodiment, a machine learning component can also be included that uses the 3D point cloud and 3D volume data to train a predictive model for quality control. The predictive model can be used to predict the quality of parts produced in future additive manufacturing processes based on past data, allowing for proactive quality control and process optimization.

In another embodiment, systems and methods according to the invention can include a feedback loop that allows for the adjustment of the 3D volume based on the results of the evaluation. For example, if the evaluation reveals a specific area of the part that consistently fails to meet quality standards, the 3D volume can be adjusted to increase the resolution and accuracy of the quality evaluation in that area.

Systems and methods according to the invention can be implemented using suitable software and hardware components, including sensors, 3D scanning devices, and computing devices capable of processing and analyzing large amounts of data.

After the quality control process is completed, the result can be visualized in 2D or 3D using a graphical device, such as a computer monitor or a virtual reality headset. The visualization can provide a detailed representation of the final part, including any areas that deviate from the desired quality standards.

The use of a graphical device to visualize the quality control results can provide several benefits, including:
Enhanced understanding of the manufacturing process: Providing a visual representation of the manufacturing process can help users better understand the process and identify areas for improvement.
Improved communication between stakeholders: The use of a graphical device can facilitate communication between different stakeholders involved in the manufacturing process, including designers, engineers, and manufacturers.
Real-time feedback and adjustments: Providing real-time feedback on the manufacturing process can allow for immediate adjustments and improvements to the process.

The graphical device can be configured to display the quality control results in a variety of formats, including 2D images, 3D models, and virtual reality simulations. The format used can be selected based on the needs of the user and the specific requirements of the manufacturing process.

Methods and apparatus for additive manufacturing quality control have been disclosed. In particular embodiments, these involve measuring physical properties of the additive manufacturing process and saving the measured data in a 3D point cloud, called PC3D. The measured properties can be material deposition temperature, melt pool temperature, speed and position laser or nozzle. As an example, in laser powder bed fusion, the measured property can be the emitted radiation from the melt pool, the measured laser power and the measured laser position. As an example, in fused deposition modelling, the measured property can be the emitted heat radiation from the filament deposition nozzle, the measured deposition speed and the measured position of the nozzle. Also disclosed is a predefined quality measure strategy defined in a 3D volume, called SD3V, where each voxel can contain a vector of quality measures and a vector of enumerated quality evaluation methods. The SD3V can be defined in different levels of detail, and in lower levels of detail, the down-sampling of the quality evaluation methods is performed by adding the methods of the contributing voxels and assigning each a weight that can be used to calculate the final quality measure by interpolation. The measured data in the PC3D can be evaluated by using it as input to the quality measures and evaluation methods defined in SD3V. This can be performed after the manufacturing process is completed or, in-situ, during manufacturing. When used in-situ, the sampled PC3D point cloud is evaluated against the SD3V volume continuously to ensure high-quality parts with minimal defects are produced. The level of detail and the vectors of SD3V can be changed, either manually or automatically during the manufacturing process as a result of previously evaluated quality or external arbitrary processes. The result of the quality evaluation is saved into a 3D volume, called Q3DV, that can, but need not be of the same resolution as SD3V.

The present invention can provide an approach for additive manufacturing quality control that addresses the challenges associated with ensuring the quality of parts produced through additive manufacturing. This involves measuring material deposition properties or powder bed fusion properties together with other process measures during the additive manufacturing process and saving the measured data as a 3D point cloud. It also includes a predefined quality measure strategy defined as a 3D volume, where each voxel can contain a vector of quality measures and vector of quality evaluation methods associated with the voxel. The 3D volume can be defined in different levels of detail, and in lower levels of detail, the down-sampling of the quality evaluation methods is performed by using weighted interpolation of the contributing voxels, for example, using bicubic interpolation. This approach evaluates the 3D point cloud against the 3D volume continuously to ensure high-quality parts with minimal defects are produced.

Manufacturing quality control systems and methods according to the invention can use a variety of different types of data for a part that is designed to be manufactured using additive manufacturing techniques. These data can include sensor values for a number of different types of physical quantities, including physical parameters such as temperature or humidity; process parameters, such as laser power; and visual information, such as image data from a camera or scanner. These can be received in a variety of forms, including individual sensor signals or data files that store information for positions in one, two, three or more dimensions.

The quality control operations can be performed in-situ on data being generated as a part as it is manufactured. It can also be applied afterwards to data acquired during manufacturing. Or it can be applied to data for the part acquired after manufacturing, such as CT scan data. It may even be applicable to data files before the manufacturing process has begun. Results from these different stages can be compared and combined in any combination. It may for example be interesting to compare pre-printing design data with actual post-printing tomography data, in order to evaluate if the manufactured product has turned out as planned. It may also be interesting to compare pre-printing design data with actual data acquired during the additive manufacturing process, regarding for example the trajectory of the laser, to evaluate whether the planned laser trajectory has in fact been followed during the additive manufacturing process.

### Example

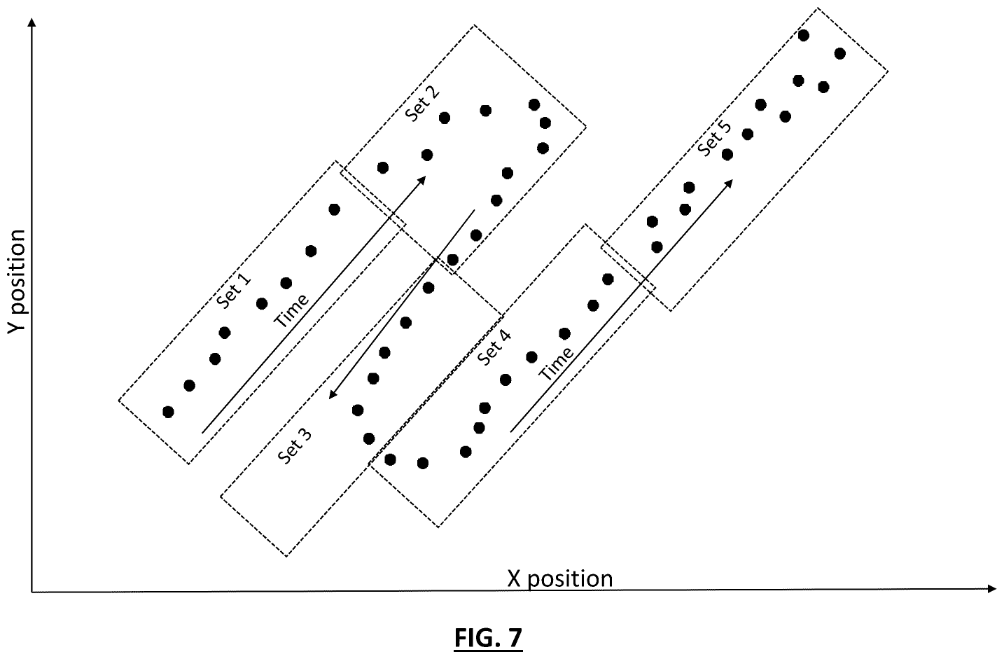

In an illustrative operation, referring to FIGS. 7A-7F, a point cloud quality measure strategy data set SV3D is first defined for an optimal laser path to manufacture a part (FIG. 7A). The initial path specification can be obtained in various ways, such as through the use of a CAD system.

A measured laser path PC3D is acquired from the manufacturing of a particular part (FIG. 7B), as well. The quality measure strategy data set SD3V, is then applied to the measured path (FIG. 7C). In this process, a 2D-slice of the quality measure strategy data set SV3D is applied to PC3D using a strategy of calculating the distance between measured (PC3D) to Optimal (SV3D) and comparing the distance with the Quality Measure (M) (FIG. 7D). The result is a 2D-slice result set slice that consists of all points in the measured data path PC3D which failed the strategy applied by the quality measure strategy data set SV3D. Together the 2D slices are stored as a three-dimensional result data set QV3D (FIG. 7E). This data set can be used to diagnose process issues or inform adjustments to the process inputs. It can also be used as training data in a machine learning process to optimize the ideal path to be used to manufacture future parts.

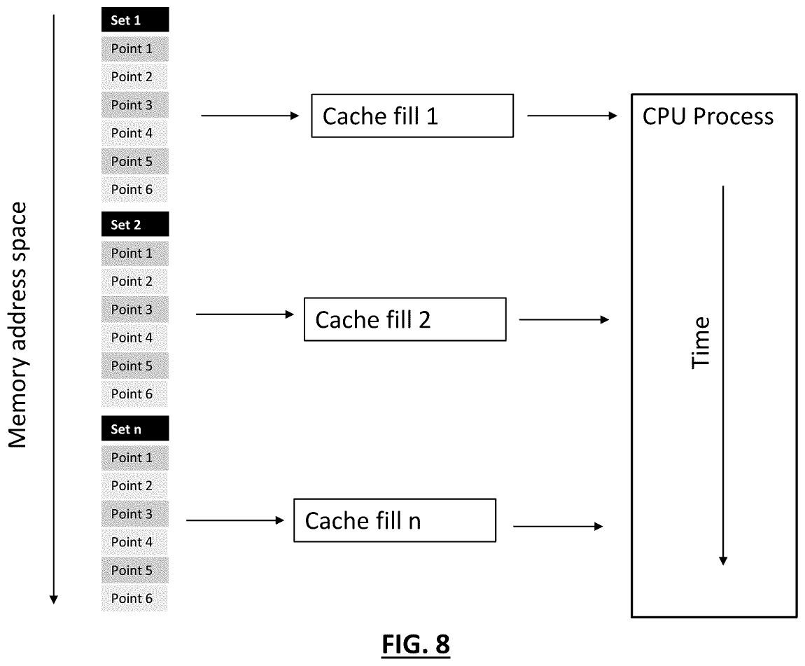

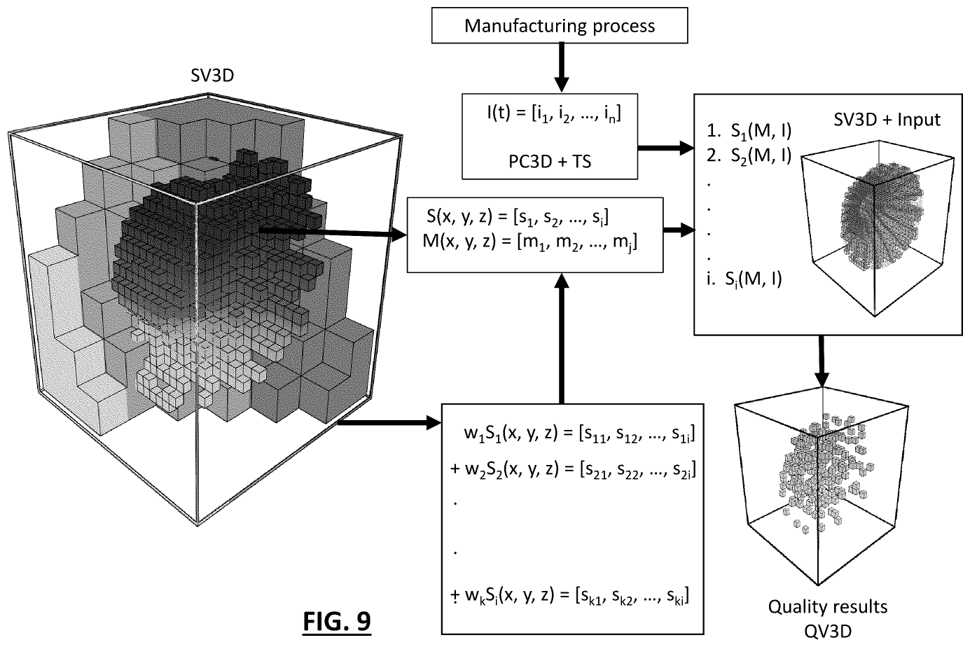

Referring to FIGS. 8 and 9, the point cloud structure is preferably structured for fast search queries. By using the laser/nozzle path, which is usually known in advance, the point cloud structure can be structured so that search during manufacturing is fast by reducing both cache misses and the need for time consuming search patterns. Points that are likely to be searched for during a given time should be stored close to each other in memory. Data can be split into different files to simplify threaded searches and help with distributing exceptionally large datasets over several memory devices. In some implementations processing can be distributed over several computer systems connected via a network. Data can be split into chunks that can be transferred and processed together to make transfer more effective and reduce cache misses. The data can be structured so that it is suited for processing on a graphics processing unit. Other volumetric structures used by the system are preferably also structured for efficient access in this way.

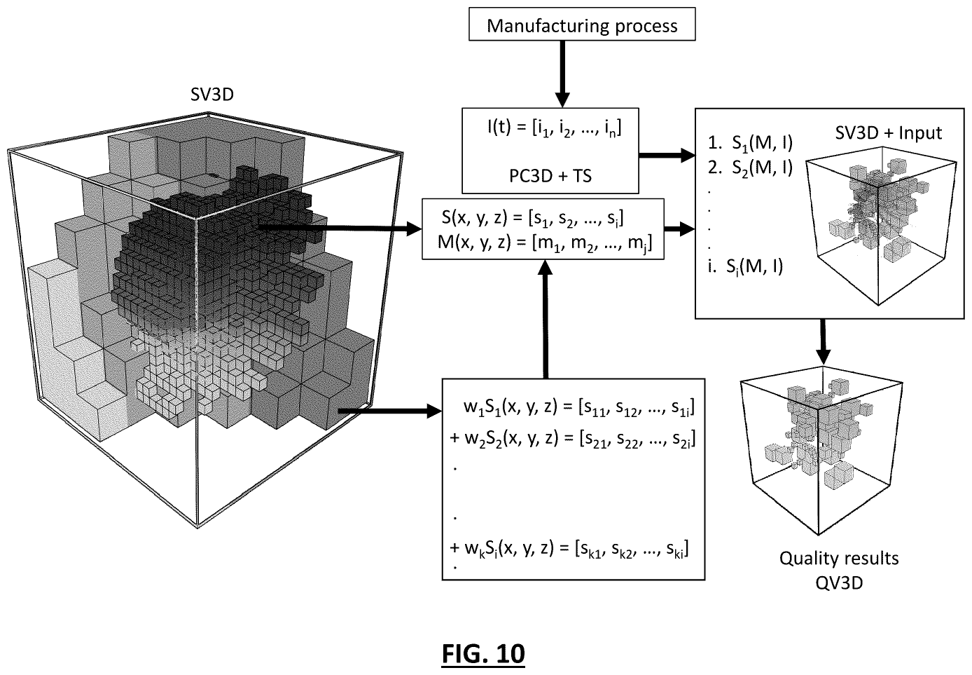

FIGS. 10 and 11 visually summarize an illustrative instance of the overall quality control process. FIG. 11 differs from FIG. 10 in that it uses a quality measure strategy data set SD3V with a mixture of voxel sizes that includes some larger ones. This leads to a three-dimensional result data set QV3D that also includes some larger voxels.

The multi-sixed voxel volumes can be stored in several ways, such as using a spatial tree structure. Each voxel represents a part of memory with its associated strategy functions coupled with quality values. To optimize speed while reducing errors such as cache misses, it should be stored in such a way where it aligns according to a specific voxel probability to be read and used in memory. This way of approach to storage provides a good foundation for multi-threading access and fast rendering.

For example, one instance of a quality measure strategy data set SV3D might be stored using a well-known octree data structure, which can efficiently manage spatial data in three dimensions. A root voxel encapsulates the entire dataset's bounding volume. By using recursive subdivision, an octree divides a three dimensional space into smaller, more granular voxels, where each voxel contains the associated quality evaluation strategy. This tree can updated and restructured according to the results of the evaluation.

The system described above has been implemented in connection with special-purpose software programs running on general-purpose computer platforms, but it could also be implemented in whole or in part using special-purpose hardware. The system can further be implemented in connection with a cloud-based or otherwise virtualized environment, and its functionality can be provided to end users as stand-alone software distributions or in software-as-a-service format. Moreover, different entities can develop and operate different parts of the system.

The system can also be broken into the series of modules and steps shown for illustration purposes, one of ordinary skill in the art would recognize that it is also possible to combine them and/or split them differently to achieve a different breakdown, and that the functions of such modules and steps can be arbitrarily distributed and intermingled within different entities, such as routines, files, and/or machines.

The present invention has now been described in connection with a number of specific embodiments thereof. However, numerous modifications which are contemplated as falling within the scope of the present invention should now be apparent to those skilled in the art. Therefore, it is intended that the scope of the present invention be limited only by the scope of the claims appended hereto. In addition, the order of presentation of the claims should not be construed to limit the scope of any particular term in the claims.

What is claimed is:

1. An additive manufacturing quality control method for a processor and a storage device including instructions configured to run on the processor, including:
receiving physical property measurement data values from different spatial positions acquired for a three-dimensional part manufactured with an additive manufacturing process,
defining a three-dimensional quality measurement volume of quality measurement voxels that are each associated with at least one quality control measure and at least one quality evaluation method, and
wherein the three-dimensional quality measurement volume of quality measurement voxels is formatted in a three-dimensional format in which a first set of the quality measurement voxels are voxels of a first size, and at least a second set of the quality measurement voxels are of a second size different from the first size.

2. The method of claim 1 wherein the defining a three-dimensional quality measurement volume of quality measurement voxels defines voxels that are each associated with a vector of the quality control measures and a vector of the quality evaluation methods.

3. The method of claim 2 further including evaluating the physical property measurement data values based on the quality control measures and the quality evaluation methods for corresponding voxels in the three-dimensional volume of quality measurement voxels.

4. The method of claim 1 further including evaluating the physical property measurement data value based on the quality evaluation measure and quality evaluation method for corresponding voxels in the three-dimensional volume of quality measurement voxels.

5. The method of claim 4 wherein the evaluation is performed in-situ during the additive manufacturing process.

6. The method of claim 4 wherein the evaluation is performed after completion of the additive manufacturing process.

7. The method of claim 4 further including of storing results of the evaluating in a three-dimensional quality evaluation result volume.

8. The method of claim 7 further including visualizing the result using a graphical device.

9. The method of claim 8 wherein the visualizing provides a detailed representation of a final part, including any areas that deviate from desired quality standards.

10. The method of claim 7 wherein the three-dimensional quality measurement volume and the three-dimensional quality evaluation result volume share a same resolution.

11. The method of claim 1 wherein the three-dimensional quality measurement volume of quality measurement voxels are adjusted by a feedback loop based on the results of evaluations.

12. The method of claim 1 wherein the three-dimensional quality measurement volume of quality measurement voxels are derived through machine learning.

13. The method of claim 1 wherein the differently sized voxels in the three-dimensional volume of quality measurement voxels are obtained by down-sampling of the quality evaluation methods for some of the voxels.

14. The method of claim 13 wherein the down sampling is performed by adding methods of contributing voxels and assigning a weight to each of the contributing voxels to calculate a quality measure by interpolation.

15. The method of claim 1 wherein the property measurements include emitted radiation from a melt pool, measured laser power, and measured laser position.

16. The method of claim 1 wherein the property measurements are in point-cloud format.

17. The method of claim 1 further including storing the defined three-dimensional quality measurement volume of quality measurement voxels in a file structure that includes a spatial tree.

18. The method of claim 1 further including storing the defined three-dimensional quality measurement volume of quality measurement voxels in a sequence that is organized to allow efficient access and caching of information for proximate voxels.

19. An additive manufacturing quality control system, including:
an input for receiving physical property measurement data values from different spatial positions acquired for a three-dimensional part manufactured with an additive manufacturing process,
logic for defining a three-dimensional quality measurement volume of quality measurement voxels that are each associated with at least one quality control measure and at least one quality evaluation method, and
wherein the three-dimensional quality measurement volume of quality measurement voxels is formatted in a three-dimensional format in which a first set of the quality measurement voxels are voxels of a first size, and at least a second set of the quality measurement voxels are of a second size different from the first size.

20. An additive manufacturing quality control system, including:
means for receiving physical property measurement data values from different spatial positions acquired for a three-dimensional part manufactured with an additive manufacturing process,
means for defining a three-dimensional quality measurement volume of quality measurement voxels that are each associated with at least one quality control measure and at least one quality evaluation method, and
wherein the three-dimensional quality measurement volume of quality measurement voxels is formatted in a three-dimensional format in which a first set of the quality measurement voxels are voxels of a first size, and at least a second set of the quality measurement voxels are of a second size different from the first size.
